(19) United States
(12) Patent Application Publication
(10) Pub. No.: US 2008/0309641 A1
(43) Pub. Date: Dec. 18, 2008

(54) INTERACTIVITY IN A LARGE FLAT PANEL DISPLAY

(76) Inventors: Jacob Harel, Redwood City, CA (US); Yao Ding, Sunnyvale, CA (US); Fredrick N. Hill, Portland, OR (US); Arthur H. Muir, III, Campbell, CA (US); Raphael Holtzman, San Mateo, CA (US)

Correspondence Address: DOV ROSENFELD, 5507 COLLEGE AVE, SUITE 2, OAKLAND, CA, 94618, US

(21) Appl. No.: 12/139,452

(22) Filed: Jun. 14, 2008

Related U.S. Application Data
(60) Provisional application No. 60/944,372, filed on Jun. 15, 2007.

(51) Int. Cl. G06F 3/041

(52) U.S. Cl. 345/173

(57) ABSTRACT

An apparatus is provided that comprises a hand held device comprising a first transmitter and a second transmitter; a flat panel display having a surface and a plurality of receivers placed near or proximate to the surface for receiving signals transmitted from the hand held device; and one or more processors coupled to the receivers such that when the hand held device is placed in close proximity to or on the surface of the flat panel display, a working area within the surface is defined, the working area interacting with the hand held device for determining a location of the hand held device in relation to the surface.

### RELATED APPLICATIONS

The present invention claims benefit of and is a conversion of U.S. Provisional Application No. 60/944,372 filed Jun. 15, 2007 to inventors Harel et al. The contents of U.S. Application No. 60/944,372 are hereby incorporated herein by reference.

### BACKGROUND

Mapping gestures using electromagnetic wave comprising infrared and mechanical wave comprising ultrasound is known. United States Patent Application No. 20080114615 to Prakash Mahesh et al. discloses a methods and systems for gesture-based healthcare application interaction in thin-air display. Mahesh patent provide a method for gesture-based interaction in a clinical environment, which further includes detecting a gesture in a thin-air display space. The method also includes identifying the detected gesture. The method still further includes translating the identified gesture to a corresponding healthcare application function. Certain embodiments provide therein a gesture detection system. The system includes a thin-air display space defined by at least one sensor configured to detect a gesture performed in the thin-air display space. The system also includes a processor configured to identify the gesture and translate the gesture to a corresponding healthcare application function.

Using mechanical wave comprising ultrasound for positioning and electromagnetic wave comprising infrared signals for timing is known. United States Patent Application No. 20030151596 to William P. Moyne et al discloses a system and method for recording writing performed on a surface. The Moyne patent discloses a system and method for recording writing performed on a surface includes a stylus and a detector assembly having a base appliance and a personality module irremovably attachable to the base appliance. The detector assembly includes a storage medium which allows the system of the present invention to track and record writing while not connected to a processing device such as a computer, printer, wireless device or hand-held device.

The pricing for large flat panel displays is plunging thanks to advances in Liquid Crystal Display (LCD) and Plasma display technologies, and strong demand as more and more flat panel displays find their way into homes, school classrooms and corporate meeting rooms. However, most such large flat panel displays sold today are used as output devices only.

Therefore, it is desirous to use large flat panel displays as input devices. Furthermore, it is also desirous to use a hand held device associated with a large flat panel display and determine a position of the hand held device in relation to the display.

### BRIEF DESCRIPTION OF THE DRAWINGS

FIG. 1 is an example of a wave refraction mechanical wave comprising ultrasound in accordance with some embodiments of the invention.

FIG. 2A shows an example of a wave refraction on heated surface in accordance with some embodiments of the invention.

FIG. 2B shows an example of a detailed depiction of the stylus of FIG. 2A in accordance with some embodiments of the invention.

FIG. 3 is an example of a system that uses a multiple receiver arrangement in accordance with some embodiments of the invention.

FIG. 4 is an example of a location system in accordance with some embodiments of the invention.

FIG. 5 is an example of an orthogonal receivers' placement scheme in accordance with some embodiments of the invention.

FIG. 6 is an example of a block diagram in accordance with some embodiments of the invention.

FIG. 7 is an example of a flowchart in accordance with some embodiments of the invention.

### DESCRIPTION OF EXAMPLE EMBODIMENTS

### Overview

An apparatus is provided that comprises a hand held device comprising a first transmitter and a second transmitter; a flat panel display having a surface and a plurality of receivers placed near or proximate to the surface for receiving signals transmitted from the hand held device; and one or more processors coupled to the receivers such that when the hand held device is placed in close proximity to or on the surface of the flat panel display, a working area within the surface is defined, the working area interacting with the hand held device for determining a location of the hand held device in relation to the surface.

A method for sensing a position of a handheld device is provided. The method comprises the steps of: placing a handheld device in a proximity of a flat surface; receiving or sensing at least one ultrasound signal and at least one infrared signal; and placing sensors on a working area of the flat surface; and processing the sensed at least one ultrasound signal and at least one infrared signal. The processing the sensed signal includes correcting for variation on propagation time of ultrasound. In one embodiment, one or more sensors of environmental parameter(s) that affect ultrasound propagation speed are included, and the correcting uses the one or more sensed environmental parameter(s). In another embodiment, two or more of the ultrasound sensors are placed at a known geometric orientation to one another, e.g., orthogonal or near orthogonal, and the correcting uses that the sensors are at the known orientation.

In one embodiment two or more of the sensors are placed in parallel

An apparatus is provided for sensing a position of a handheld device. The device comprises: a hand held device comprising a first transmitter, e.g., of ultrasound and a second transmitter, e.g., of infrared; a flat panel display having a surface and a plurality of receivers placed near or proximate to the surface for receiving signals transmitted from the hand held device; and one or more processors coupled to the receivers such that when the hand held device is placed in close proximity to or on the surface of the flat panel display, a working area within the surface is defined, the hand held device operating in the working area providing for determining the location of the hand held device in relation to the surface. At least some of the receivers include an electromagnetic wave sensor, e.g., a sensor of infrared, and a plurality of mechanical wave sensors, such as ultrasound sensors.

The processing by the processors uses the sensed signal and includes correcting for variation on propagation time of ultrasound.

One embodiment includes at least one environmental sensor for sensing one or more environmental parameters that affect the mechanical wave propagation time. The correcting uses the one or more sensed environmental parameter(s).

In another embodiment, two or more of the ultrasound sensors are placed at a known geometric orientation to one another, e.g., orthogonal or near orthogonal, and the correcting uses that the sensors are at the known orientation.

Embodiments of the present invention include a method, and apparatus, and logic encoded in one or more computer-readable tangible medium to carry out a method. The method is to use a hand held device associated with a large flat panel display and determine a position of the hand held device in relation to the display. One embodiment includes a method to use mechanical waves, such as ultrasound to determine a location on the surface of a large panel display.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

Flat Panel Displays and their Characteristics

This disclosure discusses the special characteristics associated with large flat panel displays and the design of an electronics input device to convert a regular flat panel display into an interactive working surface. By large displays are meant displays that are 37″ or more diagonally, although the invention described herein is not limited to such sizes.

Currently liquid crystal display and plasma display are the dominant large flat panel display technologies. There also are in development Organic Light Emitting Diode (OLED), and Electro-luminescent display (ELD) etc. Such other technologies may or may not successfully compete with large LCD or Plasma displays in the near future due to the cost and lack of maturity of such technologies. Therefore, the description herein will concentrate on LCD and plasma displays.

An LCD panel is typically illuminated by backlight under control of a Thin Film Transistor's (TFT). The individual pixels work as a light valves, adjusting the passage of backlight to create an image according to image data. Currently, the backlight is typically cold cathode fluorescent light. Unlike what its name suggests, cold cathode fluorescent light actually generates some heat during operation. Some of the light emission falls in the electromagnetic wave range comprising infrared range and thus can heat up the surface 200 of the display. To run more efficiently and allow dimmer control, the cold cathode fluorescent light is powered by high frequency ballast and is pulse width modulated, having frequency ranging from 30 KHz to 200 KHz with voltage of a few hundreds volt, whereby making the LCD flat panel display a source of light and electrical pollution.

In a plasma flat panel display case, each individual pixel is constructed by a pair of transparent electrodes and is sandwiched between an inert gas-filled glass panel. Under a driver's control, a few hundred volts are applied to the electrodes, which ionize the inert gas and forms plasma. In turn the ultraviolet emission from the plasma excites phosphor material therein, and thus creates a visible image. The current to form plasma creates heat, and similar to the case of LCD, the light emission includes some IR radiation, thereby creating heat as well. The high voltage applied on the array of electrodes and light emission thereby makes the plasma a source of light and electrical pollution as well.

In conclusion, both LCD and plasma flat panel displays have heat, light emission, and electrical pollution issues.

### Sound Wave Refraction

One aspect of the invention is to use mechanical waves, e.g., ultrasound to determine a location on the surface 200 of a large panel display.

Sound is known to propagate faster as the temperature rises. For example, one linear approximation of the speed of sound in the air under normal condition is:

V=331.3+0.6*T(m/s),

where V is the speed in m/s and T is the temperature in degrees Celsius, which shows sound propagates faster when the temperature is higher according to an approximate linear relationship.

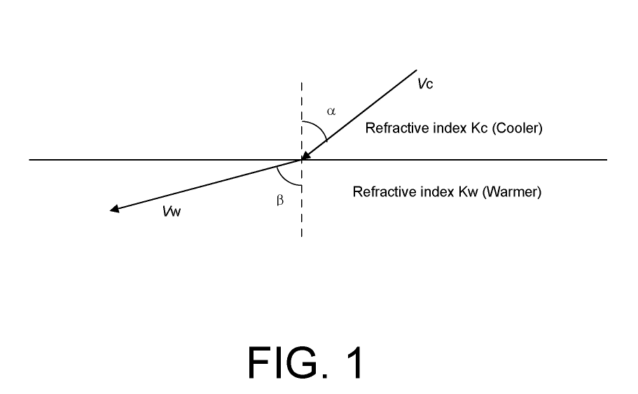

Suppose a mechanical wave emitter, e.g., ultrasound emitter is operating within a proximity of (on or close to) a heated surface 200 such as the surface 200 of a large flat panel display. The air next to the surface 200 is warmer than that that is further away. Therefore the mechanical waves, e.g., ultrasound waves travel faster. According to the theory of wave refraction and our experimental observation, the wave front of such waves as ultrasound pulse will bend towards the slower propagating media as shown is FIG. 1.

Referring to FIG. 1, “wave refraction” mechanical waves, e.g., ultrasound waves are shown. Similar to Snell's law for optics, the incident and refraction sound waves follow the following relationship:

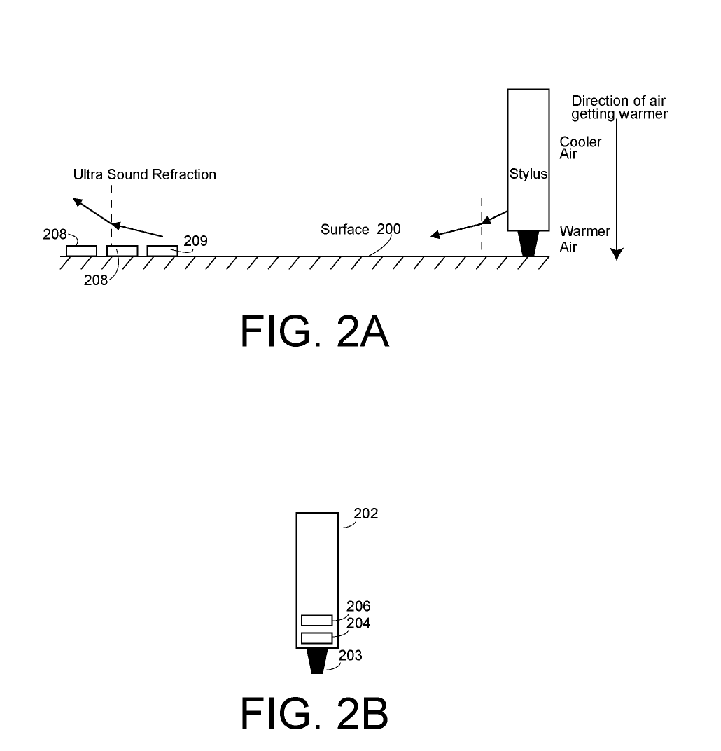

sin(α)/sin(β)=Vc/Vw=Kw/Kc Eq. 1

where Vc and Vw, and Kw and Kc are the velocity of sounds and the refractive indices, respectively in the warmer and cooler areas. α and β are the angles as shown. Therefore, refraction would tend to push sound away from a heated surface 200, e.g., the surface 200 of a large panel display, as illustrated in FIG. 2.

Referring to FIG. 2A, a wave refraction on heated surface 200 is shown. As can be seen, for a heated surface 200, mechanical wave propagation, e.g., ultrasound wave propagation is temperature dependent, and the signal strength of a wave measured close or in close proximity to the surface 200 by a receiver of such waves is in general reduced due to temperature variations in the proximity of the surface 200.

FIG. 2B shows a simple depiction of a stylus 202 that includes a tip 203. One aspect of the invention is to measure the location of a stylus 202 that includes a transmitter 204 of mechanical wave pulses, e.g., ultrasound pulses by using receivers with mechanical wave sensors 208, e.g., ultrasound sensors at known or predetermined locations near or proximate to the surface 200. In addition to the stylus 202 having the mechanical wave transmitter, e.g., ultrasound transmitter 204, in one embodiment, the stylus 202 further includes an electromagnetic wave transmitter, e.g., infrared transmitter 206. A receiver 209 of such electromagnetic wave pulses, e.g., infrared pulses also is positioned on or in close proximity to the surface 200. Assuming electromagnetic wave ray, e.g., an infrared ray travels along the surface 200 at a much faster speed than the mechanical wave pulses, e.g., ultrasound pulses, determining the difference between the arrival of an mechanical wave, e.g., ultrasound pulse and a simultaneously transmitted electromagnetic wave pulse, e.g., infrared pulse determines a measure of the distance from the stylus 202 to the receiver 208. Methods for determining location of the stylus 202 on surfaces 200 are known, e.g., using triangulation and/or another method, and such method typically do not take any heating on or near the surface 200 into account. Such methods are described in various patents assigned to Luidia, Inc., of San Carlos, Calif., including but not limited to published US Patent Applications US 20010000666, US 20010050677, US 20020167496. Furthermore, see also the following US patents assigned to the same assignee: U.S. Pat. No. 5,866,856; U.S. Pat. No. 6,046,420; U.S. Pat. No. 6,067,080; U.S. Pat. No. 6,118,205; U.S. Pat. No. 6,151,014; U.S. Pat. No. 6,184,873; U.S. Pat. No. 6,265,676; U.S. Pat. No. 6,266,051; U.S. Pat. No. 6,292,177; U.S. Pat. No. 6,300,580; U.S. Pat. No. 6,323,893; U.S. Pat. No. 6,326,565; U.S. Pat. No. 6,335,723; U.S. Pat. No. 6,373,003; U.S. Pat. No. 6,414,673; U.S. Pat. No. 6,424,340; U.S. Pat. No. 6,456,280; U.S. Pat. No. 6,501,461; U.S. Pat. No. 6,549,230; U.S. Pat. No. 6,571,643; U.S. Pat. No. 6,731,270; U.S. Pat. No. 6,786,102; U.S. Pat. No. 6,822,641; U.S. Pat. No. 6,875,933; and U.S. Pat. No. 7,221,355

To compensate for the effects of the rise in temperature, one or more arrangements can be made. The arrangements include one or more of:
Increasing the mechanical wave output power, e.g., ultrasound output power and reduce the mechanical wave ringing, e.g., ultrasound ringing in the stylus 202.
Stacking up multiple mechanical wave sensors, e.g., ultrasound sensors to minimize temperature dependency.
Increasing the sensitivity of the mechanical wave sensors, e.g., ultrasound sensors, by using, for example, use a discrete Low Noise Amplifier (LNA).
Connecting multiple receivers to Digital Signal Procession Unit (DSP), thereby create actively switched zoning based on where the pen or stylus 202 is, as illustrated below to increase the size.
Using temperature sensor to compensate the variation in the time of flight of the mechanical waves, e.g., ultrasound. When more than one set of receivers 208 are used, a compensation method associated therewith can calculate the temperature based on redundant sets of coordinates.
Adding Z direction offset in the receiver 208 and stylus 202, where the z-direction is perpendicular to the plane of the surface.

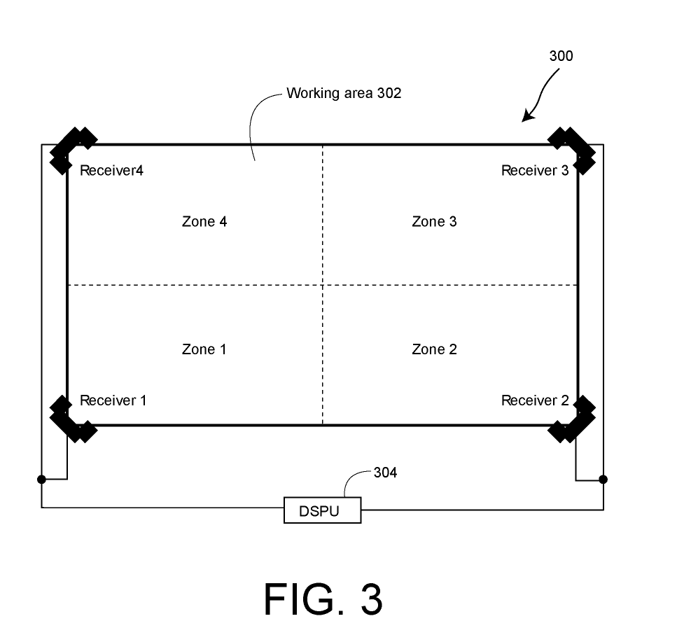

Referring to FIG. 3, one embodiment of a system that uses a multiple receiver arrangement 300 is shown. The surface 200 is formed out of four zones (zone1 to zone4) with each zone having an associated receiver (receiver1 to receiver4) positioned in close proximity thereto. Each receiver is respectively coupled to a digital signal processing unite (DSPU) The four zones form a working area 302.

### Air Movement

Another aspect that relates to determining location using, e.g., mechanical wave, e.g., ultrasound, is air movement resulting from the generations of heat. Air is less dense when it is heated, e.g., by the surface 200 of a large panel display, and would move upward, potentially creating local whirlpools and mini-turbulences. When a mechanical wave, e.g., ultrasound based location system is used, such air movement affect the mechanical wave, e.g., ultrasound wave's propagating time and thereby create what is termed “wandering reception.”

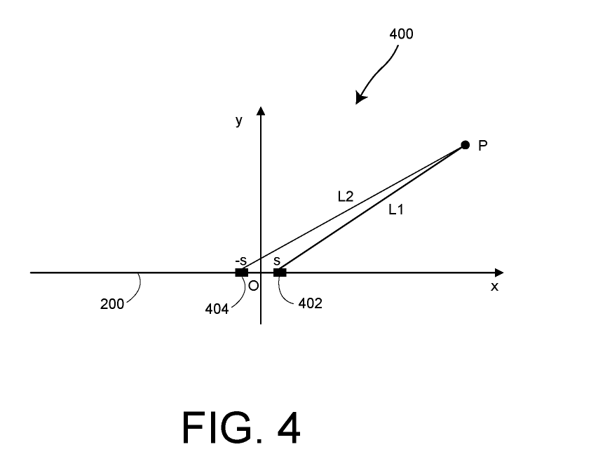

Referring to FIG. 4, a location system 400 uses a pair of receivers, a first sensor 402 and a second sensor 404, to carry out triangulation on a two-dimensional surface 200. This scheme is denoted as a “2D Triangulation with 2 Receivers”.

As shown, suppose two sensors, first sensor 402 and second sensor 404, are located respectively at co-ordinate (−s,0) and (s,0) along what is defined as the horizontal, e.g., x-axis, and suppose a stylus 202 emitting mechanical wave pulses, e.g., ultrasound pulses is at location P which can move in time. The distances from the moving point P to sensors are denoted L1 and L2, respectively.

Therefore, we have the following two equations:

(L1)̂2=ŷ2+(x−s)̂2 Eq. 2

(L2)̂2=ŷ2+(x+s)̂2, Eq. 3

wherein “̂” denoted exponentiation. Assuming y≧0, one can use a method, such as a computer implemented method, solves the equations as follows:

x=((L2)̂2−(L1)̂2)/(4*s) Eq. 4

y=((L2̂2−((L2)̂2−(L1)̂2+4*ŝ2)/(4*s))̂(½) Eq. 5

In one embodiment, an estimate of the coordinate sensitivity to the variation in L1 and L2 may be obtained by taking a partial derivatives on x and y to arrive at the following four equations:

∂(x)/∂(L1)=−L1/(2*s) Eq. 6

∂(x)/∂(L2)=L2/(2*s) Eq. 7

∂(y)/∂(L1)=(½)*((L1̂2−((L1)̂2−(L2)̂2+4ŝ2)/(4*s))̂(−½)*((4*s−1)*L1/(2*s)) Eq. 8

∂(y)/∂(L2)=(½)*((L2̂2−((L2)̂2−(L1)̂2+4ŝ2)/(4*s))̂(−½)*((4*s−1)*L2/(2*s)), Eq. 9

where “*” denotes multiplication.

In order to have a relatively small non-receiving area, one arrangement includes spacing the receivers relatively close together, e.g., such that the receiver spacing 2*s is much less than L1 or L2. As ∂(x)/∂(L1) and ∂(x)/∂(L2) is inversely proportional to 2*s, a small change in L would result in a big change in x along x-coordinate. To see this, L1≈L2. Then

∂(y)/∂(L1)≈∂(y)/∂(L2)≈1

The y sensitivity grows when the difference between L1 and L2 gets bigger.

Suppose, as an example, the receivers are placed in corner locations. Further, assume |y/x|>1.

Based on the analysis above, the variation of either L1, or L2 poses greater effect on the coordinate x. this result will be more significant when the ratio of transmitter to receiver distance over receiver to receiver distance is increased.

Although one aspect of the invention deals with the conclusions of the above analysis, the present invention does not depend on the correctness of the above analysis, and no such correctness is asserted here. The analysis is merely provided as an example to show the reasoning in coming up with the invention.

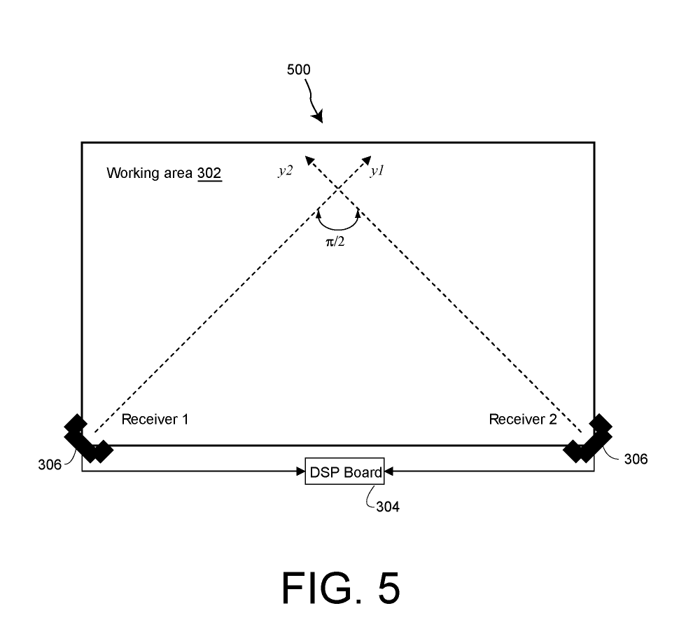

Referring to FIG. 5, an orthogonal receiver placement scheme 500 is shown. To minimize the issue resulting from the sensitivity, one exemplified implementation places two sets of receivers, a first receiver 306 and a second receiver 308, at orthogonal locations along a surface 200. The receivers are coupled to a DSP board 304 that includes interface electronics and suitable processors, e.g., DSP devices to determine the location. The signals received at each set of receivers are used by the DSP board 304 to determine the target coordinate (x1,y1) and (x2,y2) for receiver set 1 and receiver set 2, respectively. After coordinate translation, those in the art will readily see x1, y2 or x2, y1 representing the same coordinates. As the y direction is less sensitive to the mechanical wave, e.g., ultrasound time-of-flight variation, one embodiment determines the coordinate of an unknown stylus 202 location by using different weightings to determine the coordinate.

### Electromagnetic Wave Comprising Infrared Emission

As described above, flat panel displays also might generate electromagnetic wave radiation, e.g., infrared (IR) radiation. Also as described above, in one embodiment of the invention, the stylus 202 transmits an electromagnetic wave pulse, e.g., infrared pulse as well as one or more mechanical wave pulse(s), e.g., ultrasound pulse(s). The IR emission from the panel may affect the system, e.g. producing noise in the IR range. Such IR noise might be sufficiently high to cause problems detecting the IR pulse from the stylus 202, and in some architectures an IR amplifier is included. However, saturation may occur in the IR amplifier, thereby making digital domain process difficult.

### Active Analog Infrared Canceling.

One embodiment of the invention includes a second channel IR receiver (not shown) placed facing a direction from which noise might be expected—the so-called ambient direction—to sense IR noise. Such sensed noise forms a reference signal. In one embodiment, the gain for the channel sensing the noise reference is actively adjustable to adapt to variation in noise reception due to the change in displayed image, to user movement, or to both user movement and the displayed image. User movement might affect IR noise because of reflection from the user. In one embodiment, the sensed and amplified noise signal is subtracted from the IR signal detected as a result of the stylus 202 transmitted IR. Such active noise cancelling is particularly useful when there is nonlinear IR reception, e.g. when the IR amplifier goes into saturation.

Another embodiment uses noise cancelling IR interference removal. One embodiment uses a method described in U.S. patent application Ser. No. 11/038,991 filed Jan. 20, 2005 by inventors Weaver et al., entitled “INTERFERENCE REMOVAL IN POINTING DEVICE LOCATING SYSTEMS. The contents of such U.S. patent application Ser. No. 11/038,991 are hereby incorporated herein by reference.

### Phase Lock Loop and Infrared Recovery

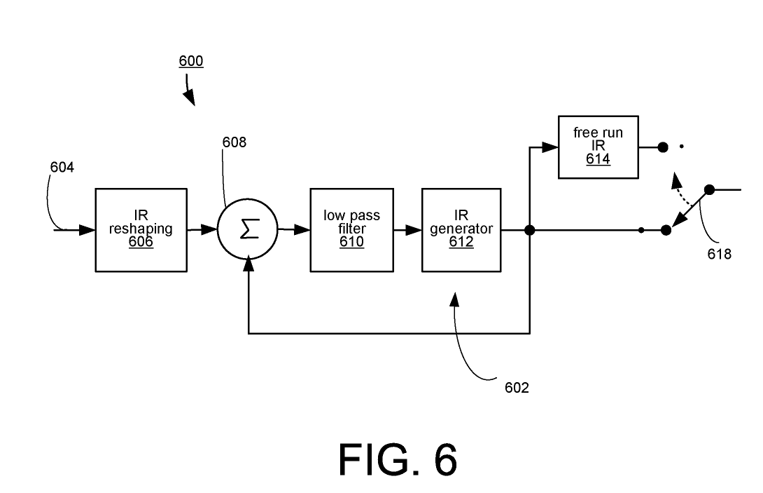

One embodiment includes a phase locked loop (PLL) for the electromagnetic wave recovery, e.g., IR recovery. Referring to FIG. 6, a block diagram 600 of one embodiment that includes a phase locked loop (PLL) 602 and IR recovery is shown. The incoming IR data 604 is reshaped by an IR reshaper 606 to fit in the IR phase detection. The IR reshaped information first passes through an adder 608, and then is subjected to a low pass filter 610. The low-pass filtered information is fed into an IR pulse generator 612 and turns into a recreated IR information. The recreated IR goes back to the other input of the phase detector and forms a closed loop tracking, or PLL.

In one state, the PLL generates the IR signal. Under certain situations, the IR signal from the stylus 202 may be physically blocked by an object or shadowed by an IR noise from the ambient. One embodiment of the system includes the stylus 202 generating a positive “pen-up” package. If the system doesn't receive a positive “pen-up” package from the stylus 202, a switch is toggled to a state called Free Run IR (FRIR) state 614 which creates IR data based on the timing history of the locked stylus 202. In such an embodiment, a history sensed timing from signals sent by the stylus 202 is maintained. Furthermore, in such an arrangement, the mechanical wave, e.g., ultrasound timing as calculated based on the FRIR 614 is verified against the maintained history to check for any anomaly. The confidence in the FRIR 614 increases when mechanical wave, e.g., ultrasound detection yields positive result, and decreases when coordinate mismatch occurs, e.g., when a stylus 202′ coordinate changes toward certain direction at certain speed and acceleration. A mismatch is an event when the course of the movement is not reasonable.

A switch 618 determined whether to subject the IR signal output from PLL 602 to FRIR 614 or not.

One method programmed into one or more processors is operative to decide to terminate using the FRIR 614 and to toggle the switch 618 and maintain the PLL 602 output as the output of block diagram 600 when any of the following occurs:
The PLL 602 resumes operation (blockage removed).
No positive mechanical wave, e.g., ultrasound is detected.
Significant coordinate mismatch occurs.
If 2 or more receivers are used, after detected positive mechanical wave, e.g., ultrasound signal away from the surface 200 (based on the 3D result).
Maximum time-out in using FRIR occurs.

In one embodiment, software in a host computer system to which the DSP board of the location determining system (the system that includes the mechanical wave, e.g., ultrasound receivers, the IR receiver(s), and the DSP board) is coupled, e.g., by wired or wireless connection, is operative to correct any mismatch between the coordinates generated from FRIR and subsequent resumption of the PLL operation.

### Electrical Interference

The flat panel display's backlighting may require relatively high voltage, e.g., up to 1 KV when starting, and relatively high current, e.g., up to 10A in the case a switching regulator is used, noise may be included in the 30 KHZ to 200 KHz range in which some of the mechanical wave, e.g., ultrasound circuitry may be required to operate. The above are taken into consideration, in that careful circuit design, including shielding the printed circuit board are used, and shielded cabling is also used, and careful consideration regarding where and how the receivers and cables are placed is used as well.

### A Method

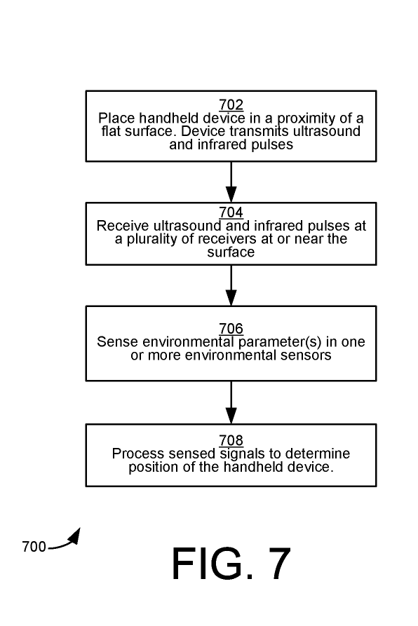

Referring to FIG. 7, a flowchart 700 for determining a location of a handheld device. The handheld device is placed in a proximity of a flat surface (Step 702). The flat surface may be a flat panel display, or any one of the other types of flat surfaces described herein the present patent application. The handheld device has at least one built-in mechanical wave transmitter, e.g., ultrasound transmitter and at least one electromagnetic wave transmitter, e.g., infrared transmitter. A plurality of receivers placed near the surface of the flat panel display receives or senses the transmitted ultrasound and infrared signals respectively (Step 704). The hand held device may be a stylus, or other hand held devices described in the present application. The method includes in 708 processing the sensed signals using at least one processor coupled to the sensors and various memories described herein the present application. The processing includes correcting for variations in propagation time of the ultrasound. In one embodiments, at least one environmental sensor is included in a proximity of the surface for sensing one or more environmental parameter(s) that affect the ultrasound propagation time, such as, but not limited to, temperature, air pressure, etc. Step 706 includes sensing one or more of the environmental parameters. In another version, each ultrasound receiver or sensor includes one or a plurality of sensors on each location along the surface. In the case where there are a plurality of sensors, the plurality of sensors are coupled in parallel, and in one embodiment, are placed with the same x and y coordinate on the working area with z direction offset. In yet another embodiment, a plurality of the ultrasound sensors are placed at known geometric orientation, e.g., in orthogonal or near orthogonal orientation to a second set of receivers or sensors. For example, near orthogonal is between 85 and 95 degrees to each other. For yet another example, near orthogonal is between 80 and 100 degrees to each other. The known relationship is used for correcting for variation in the propagation time.

### An Apparatus

As can be appreciated, the present invention describes an apparatus including a stylus that includes an ultrasound transmitter and an infrared transmitter, a plurality of receivers placed near the surface of a flat panel display, with one or more processors coupled to the receivers. For example, in the form of signal processing units. The apparatus is placed near the surface of the flat panel display to define a working area such that in operation, the surface of the working area becomes interactive in that the location of the stylus may be determined. The stylus may include one or more buttons. The receivers are able to detect that the one or more buttons are pressed as well as the location of the stylus at the time of button pressing.

The one or more processors may be coupled wirelessly or by wire to a host processing system. The host processing system is operative to receive a series of states and locations information of the stylus. The information includes whether or not any buttons are pressed in the case where the stylus includes buttons. the host processing system includes a sixth memory containing software that when executed is operative to comprise an algorithm to correct any mismatch between coordinates generated from a free run IR method and subsequent resumption of a phase locked loop method of generating an IR signal.

The working area can be one or more of an LCD display, a plasma display, and/or a rear projection display, or a combination of such displays.

At least some of the receivers include electromagnetic wave based sensors, such as but not limited to, infrared (IR) sensors. A plurality of mechanical wave based sensors is included therein as well. Mechanical wave based sensors include, but not limited to, ultrasound sensors.

In one embodiment, t least one environmental sensor is included for sensing environmental parameters which affect the ultrasound propagation time, such as, but not limited to, temperature, air pressure, etc. The mechanical wave sensors are ultrasound transducers that can serve as both sensors and transmitters, such that a calibration method can be used using the one or more ultrasound transducers transmitting and one or more transducers receiving.

The stylus comprises primary and secondary inductors that store magnetic flux that are closely coupled together. The secondary to primary inductors' winding turn ratio being greater than 1. The primary inductors are turned on for a predetermined time and then turned off. the magnetic flux stored in the primary inductors is released, and the magnetic flux coupled into the secondary inductors is also released at the juncture when the primary inductor turning off, thereby forming an increased ultrasound power output to drive a piezo film included in the stylus, so that an ultrasound pulse is produced, with ringing in the secondary inductor reduced due to the close coupling. The mechanical wave sensors are ultrasound sensors. Each mechanical wave receiver includes one or a plurality of sensors on each location along the surface. In the case where there are a plurality of sensors, the plurality of sensors are coupled in parallel, and are placed with the same x and y coordinate on the working area with z direction offset.

### Multiple Sets of Receivers

A plurality of sets of receivers is arranged so as to extend the area of the working surface in contrast to only using a pair of mechanical wave sensors along with one electromagnetic wave sensor. The plurality of receivers is coupled to an equal or smaller number of processors, e.g., signal processing units. A first memory is included within the signal processing units containing software when executed by one or more processors implementing a first method to actively manage the plurality of said receivers and selectively couple the signals of interest to one or more of the relevant processing units. In some cases, the receivers are placed in near orthogonal orientation to other receivers. For example, near orthogonal is between 85 and 95 degrees to each other. For yet another example, near orthogonal is between 80 and 100 degrees to each other. Furthermore, a second memory is included containing software such that when executed by one or more processors, a second method is implemented to calculate the styli position based on the coordinates from a plurality of receivers with greater weighting associated with the coordinate which has less sensitivity to the ultrasound time-of-flight variation, and lesser weighting associated with the coordinate which has greater sensitivity to the ultrasound time-of-flight variation. The receivers still further include a plurality channels of ambient IR sensors. The ambient IR sensors' most sensitive directions are positioned away from the working area. A third memory is included containing software when executed by one or more processors implementing a method to adjust the gain. an amplifier amplifies information sensed from the ambient IR sensors. The apparatus further actively subtract the ambient IR noise from the main said IR sensors. A fourth memory is included containing software when executed by one or more processors implementing a method to implement an infrared phase locked loop method and a method of running in a free run IR state. The output of the method is the result of either the infrared phase locked loop method, or the free run IR state method. A switch for a switch-over between the two states is actively managed based on one or more pre-defined conditions. The apparatus further comprises a fifth memory to store timing data for received signals when the phase locked loop state is active. The free run IR method recreates IR data based on the data generated by the phase locked loop method is stored in the fifth memory, with greater weighting associated with the most recent data. The free run IR method is operative to generate the same IR data when the phase lock loop method stops operating. The free run IR method is operative to track the phase locked loop method output immediately when the phase locked loop method resumes.

The apparatus further includes at least one environmental sensor for sensing environmental parameters which affect the ultrasound propagation time, wherein a memory is included containing software when executed by one or more processors implementing a method to calculate the current speed of ultrasound based on the parameters coupled from the one or more environmental sensor.

A seventh memory is included containing software when executed by one or more processors implementing a method to calculate the current speed of ultrasound based on redundant coordinates generated from a plurality of said receivers.

The receivers have fixed or adjustable Z directional offset. The z-direction being orthogonal to the surface of the flat panel display having x-y coordinates formed thereon. The offset is compensated for using a first calibration method.

The stylus has fixed or adjustable Z directional offset. The Z-direction is the direction orthogonal to the surface having x-y coordinates formed thereon. The offset is compensated for using a second calibration method.

The stylus includes a tip and has a temperature sensor located at the tip. The stylus also sends information regarding the temperature around the tip to the receivers encoded in one or more signals transmitted by the stylus.

One or more secondary working areas next to the primary working area is provided or formed. Examples of the secondary working areas include a table where the flat panel displays are placed on, with a plurality of receivers are placed in the secondary working area for capturing the position and possibly state of the stylus when the stylus moves into the secondary working area.

### General

In one embodiment, a computer-readable computer readable medium carries a set of instructions that when executed by one or more processors of a location determining system cause the one or more processors to carry out a method in the location determining system.

It should be appreciated that although embodiments of the invention have been described in the context of LCD or plasma displays, the present invention is not limited to such contexts and may be utilized in various other applications and systems.

While IR pulses and one or more IR receivers are included, other electromagnetic wave transmitters and receivers may be included in alternate embodiments.

While ultrasound pulses and a plurality of ultrasound sensors are used in one embodiment, in alternate embodiments, other forms of mechanical waves, and of sensors of such mechanical waves are used.

Furthermore, while in one system, the stylus 202 transmits the mechanical wave pulses, e.g., ultrasound wave pulses and electromagnetic wave pulses, e.g., infrared pulses, and receivers are placed at locations near the surface 200 of the flat panel display, alternate embodiments have receivers in the stylus 202, and transmitters at various locations, e.g., at some distance from the surface

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., steps is implied, unless specifically stated.

Some of the methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable computer readable medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable computer readable medium on which is encoded logic, e.g., in the form of instructions.

Furthermore, a computer-readable computer readable medium may form, or be includes in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the logic including instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable computer readable medium carrying a set of instructions, e.g., a computer program that are for execution on one or more processors, e.g., one or more processors that are part of location determining system. Thus, as will be appreciated by those skilled in the art, embodiments of the present invention may be embodied as a method, an apparatus such as a special purpose apparatus, an apparatus such as a data processing system, or a computer-readable computer readable medium, e.g., a computer program product. The computer-readable computer readable medium carries logic including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of computer readable medium (e.g., a computer program product on a computer-readable storage medium) carrying computer-readable program code, e.g., software embodied in the medium.

The software may further be transmitted or received over a network via a network interface device. While the computer readable medium is shown in an example embodiment to be a single medium, the term “computer readable medium” should be taken to include a single medium or multiple media (e.g., a centralized or distributed database, and/or associated caches and servers) that store the one or more sets of instructions. The term “computer readable medium” shall also be taken to include any medium that is capable of storing, encoding or carrying a set of instructions for execution by one or more of the processors and that cause the one or more processors to perform any one or more of the methodologies of the present invention. A computer readable medium may take many forms, including but not limited to, non-volatile media and volatile media. Non-volatile media includes, for example, optical, magnetic disks, and magneto-optical disks. Volatile media includes dynamic memory, such as main memory. For example, the term “computer readable medium” shall accordingly be taken to included, but not be limited to, in one set of embodiments, a tangible computer-readable medium, e.g., a solid-state memory, or a computer software product encoded in computer-readable optical or magnetic media.

It will be understood that the steps of methods discussed are performed in one embodiment by an appropriate processor (or processors) of a processing (i.e., computer) system executing instructions stored in storage. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the DESCRIPTION OF EXAMPLE EMBODIMENTS are hereby expressly incorporated into this DESCRIPTION OF EXAMPLE EMBODIMENTS, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. An apparatus comprising:
a hand held device comprising a first transmitter that includes a mechanical wave transmitted and a second transmitter that includes an electromagnetic wave transmitter;
a flat panel display having a surface and a plurality of receivers placed near or proximate to the surface for receiving signals transmitted from the hand held device; and
one or more processors coupled to the receivers such that when the hand held device is placed in close proximity to or on the surface of the flat panel display, a working area within the surface is defined, the working area interacting with the hand held device for determining a location of the hand held device in relation to the surface;
wherein at least some of the receivers include electromagnetic wave based sensors, and a plurality of mechanical wave based sensors,
wherein the one or more processors are configured to correct for non-uniformities to the mechanical wave propagation time.

2. The apparatus as recited in claim 1, wherein the hand held device comprises a stylus.

3. The apparatus as recited in claim 1, wherein the receivers include at least one environmental sensor for sensing one or more environmental parameters that affect the mechanical wave propagation time.

4. The apparatus as recited in claim 1, wherein the mechanical wave transmitter comprises an ultrasound transmitter.

5. The apparatus as recited in claim 1, wherein the electromagnetic wave transmitter comprises an infrared transmitter.

6. The apparatus as recited in claim 1, wherein the stylus comprises one or more buttons such that the receivers are able to detect that some of the one or more buttons are pressed and a location of the stylus at the time of pressing.

7. The apparatus as recited in claim 1, wherein the hand held device comprises a primary inductor and a secondary inductor both storing magnetic flux that are closely coupled, winding turn ratio of the secondary to the primary inductor being greater than 1.

8. The apparatus as recited in claim 1, wherein, in the case there are a plurality of sensors, the plurality of sensors are coupled in parallel, and are placed with the same x and y coordinate on the working area having a z direction offset.

9. The apparatus as recited in claim 1, wherein at least two of the mechanical wave transducers are oriented with a known geometric relationship to one another, and wherein the known geometric relation is used together with measurements that are affected by the propagation time to correct for the non-uniformities.

10. The apparatus as recited in claim 9, wherein a first receiver is placed in substantially orthogonal orientation to a second receiver.

11. The apparatus as recited in claim 1, wherein the receivers have fixed or adjustable Z directional offset, the z-direction being orthogonal to the surface of the flat panel display, and wherein the offset is compensated for using a first calibration method.

12. The apparatus as recited in claim 1, wherein the hand held device has fixed or adjustable Z directional offset, the Z-direction being the direction orthogonal to the surface, and wherein the offset is compensated for using a second calibration method.

13. A method comprising the steps of:
placing a handheld device in a proximity of a flat surface;
receiving or sensing a least one ultrasound signal at a plurality of ultrasound sensors, and at least one infrared signal at one or more infrared sensors, the sensors located on or close to the flat surface; and
processing the sensed at least one ultrasound signal and at least one infrared signals to determine the location of the handheld device, including correcting for non-uniformities to the mechanical wave propagation time.

14. The method as recited in claim 13, further comprising one or more of:
Stacking up multiple mechanical wave sensors to reduce temperature dependency of the propagation time;
increasing the sensitivity of the mechanical wave sensors, e.g., ultrasound sensors, by using, for example, use a discrete low noise amplifier;
connecting multiple receivers to a digital signal procession unit to create actively switched zoning based on where the pen or stylus; and/or
using temperature sensor to compensate the variation in the time of flight of the mechanical waves, e.g., ultrasound. When more than one set of receivers 208 are used, a compensation method associated therewith can calculate the temperature based on redundant sets of coordinates; and/or
adding z direction offset in the receiver 208 and stylus 202, where the z-direction is perpendicular to the plane of the surface 14.

15. The method as recited in claim 13 further comprising the step of sensing one or more environmental parameters which affect the ultrasound propagation time, and using the sensed one or more environmental parameters in the correcting for non-uniformities.

16. The method as recited in claim 15, wherein the environmental parameters comprise a temperature.

17. The method as recited in claim 13, wherein more than one sensor is places at the same x and y location, including stacking different sensors with a z-coordinate offset.

18. The method as recited in claim 13, wherein two or more of the ultrasound sensors are places at known geometric orientation to one another, and wherein the correcting for non-uniformities uses the known orientation.

19. The method as recited in claim 13, wherein the two or more of the ultrasound sensors are placed substantially orthogonal to one another such that the known orientation is substantial orthogonality.

20. The method as recited in claim 13, wherein the processing step comprises using at least one processor coupled to the sensors.

21. The method as recited in claim 20, wherein the coupling between the sensors and the at least one processor is via wireless means.

22. The method as recited in claim 20, wherein the coupling between the sensors and the at least one processor is via wire line means.

23. An apparatus comprising:
a stylus including an electromagnetic wave transmitter and a mechanical wave transmitter,
a plurality of receivers placed near the surface of a flat panel display, the receivers including at least one electromagnetic wave based sensor, and a plurality of mechanical wave based sensors; and
one or more processors coupled to the receivers, the processors configured to determine the position of the stylus on a working area defined on the surface when the stylus is transmitting, including correct for variation in propagation time of the mechanical waves.

24. The apparatus as recited in claim 23, further comprising:
at least one environmental sensor for sensing one or more environmental parameters which affect the mechanical wave propagation time;
wherein the determining of the position takes into account the environmental parameter or parameters sensed by the at least one environmental sensor to correct for propagation time variation.

25. The apparatus as recited in claim 23, wherein at least two of the mechanical wave sensors have known geometric orientation to one another, such that the correcting for variation in propagation time of the mechanical waves takes into account the known geometric orientation.

26. An apparatus as recited in claim 23, wherein the one or more processors are coupled to a host processing system, and wherein the host processing system is operative to receive series of states and locations of the stylus, including whether or not any buttons are pressed in the case the stylus includes buttons.

27. An apparatus as recited in claim 23, wherein the flat panel display includes one or more of an LCD display, a plasma display, and/or a rear projection display, or combination of such displays.

28. An apparatus as recited in claim 23, wherein the mechanical wave sensors are ultrasound sensors, and wherein each mechanical wave receiver includes one or a plurality of sensors on each location along the surface, wherein, in the case there are a plurality of sensors, the plurality are coupled in parallel, and are placed with the same x and y coordinate on the working area with z direction offset.

29. An apparatus recited in claim 23, comprising a plurality of sets of receivers arranged to extend the area of the working surface compared to only using a pair of mechanical wave sensors and one electromagnetic wave sensor, wherein the plurality of receivers are coupled to an equal or smaller number of processors.

30. An apparatus as recited in claim 29, wherein a memory is included containing software when executed by one or more processors implementing a method to actively manage the plurality of said receivers and only couple the signals of interest to one or more of the relevant processing units.

31. An apparatus as recited in claim 29, wherein at least two of the mechanical wave sensors are places with orthogonal or near orthogonal orientation to one another, such that the correcting for variation in propagation time of the mechanical waves takes into account the known geometric orientation

32. An apparatus as recited in claim 31, wherein near orthogonal orientation is between 85 and 95 degrees to each other.

33. An apparatus as recited in claim 32, wherein near orthogonal orientation is between 80 and 100 degrees to each other.

34. An apparatus as recited in claim 29, wherein a memory is included containing software when executed by one or more processors implementing a method to calculate the styli position based on the coordinates from a plurality of receivers, with greater weighting associated with the coordinate which has less sensitivity to the ultrasound time-of-flight variation, and lesser weighting associated with the coordinate which has greater sensitivity to the ultrasound time-of-flight variation.

35. An apparatus as recited in claim 29, wherein the receivers include a plurality channels of ambient IR sensors, the ambient IR sensors' most sensitive directions being positioned away from the working area.

36. An apparatus as recited in claim 35, wherein a memory is included containing software when executed by one or more processors implementing a method to adjust the gain and includes an amplifier of said ambient IR sensors, and to actively subtract the ambient IR noise from the main said IR sensors.

37. An apparatus as recited in claim 35, wherein a memory is included containing software when executed by one or more processors implementing a method to implement an infrared phase locked loop method and a method of running in a free run IR state, wherein the output of the method is the result of either the infrared phase locked loop method or the free run IR state method, with switch-over between the two states actively managed based on one or more pre-defined conditions.

38. An apparatus as recited in claim 37, further comprising a memory to store timing data for received signals when the phase locked loop state is active, wherein the free run IR method recreates IR data based on the data generated by the phase locked loop method stored in the memory, with greater weighting associated with the most recent data, and wherein the free run IR method is operative to generate the same IR data when the phase lock loop method stops operating, and wherein the free run IR method is operative to track the phase locked loop method output immediately when the phase locked loop method resumes.

39. An apparatus as recited in claim 26, wherein the host processing system includes a memory containing software that when executed is operative to comprise an algorithm to correct any mismatch between coordinates generated from a free run IR method and subsequent resumption of a phase locked loop method of generating an IR signal.

40. An apparatus as recited in claim 29, further comprising at least one environmental sensor for sensing environmental parameters which affect the ultrasound propagation time, wherein a memory is included containing software when executed by one or more processors implementing a method to calculate the current speed of ultrasound based on the parameters coupled from the one or more environmental sensor.

41. An apparatus as recited in claim 29, wherein a memory is included containing software when executed by one or more processors implementing a method to calculate the current speed of ultrasound based on redundant coordinates generated from a plurality of said receivers.

42. An apparatus as recited in claim 23, wherein the receivers have fixed or adjustable Z directional offset, the z-direction being orthogonal to the surface of the flat panel display, and wherein the offset is compensated for using a calibration method.

43. An apparatus as recited in claim 23, wherein the stylus has fixed or adjustable Z directional offset, the Z-direction being the direction orthogonal to the surface, and wherein the offset is compensated for using a calibration method.

44. An apparatus as recited in claim 23, wherein the stylus includes a tip and has a temperature sensor located at the tip, and sends the temperature around the tip to said receivers encoded in one or more signals transmitted by the stylus.

45. An apparatus as recited in claim 23, wherein the mechanical wave sensors are ultrasound transducers that can serve as both sensors and transmitters, such that a calibration method can be used using the one or more ultrasound transducers transmitting and one or more transducers receiving.

46. An apparatus as recited in claim 27, further comprising one or more secondary working areas next to a main working area, such as a table where the flat panel displays are placed on, and wherein a plurality of receivers are placed in the secondary working area for capturing the position and possibly state of the stylus when the stylus moves into the secondary working area.
